(19) United States
(12) Patent Application Publication
(10) Pub. No.: US 2007/0201315 A1
(43) Pub. Date: Aug. 30, 2007

(54) Timepiece

(76) Inventor: Kei Hirano, Chiba-shi (JP)

Correspondence Address: BRUCE L. ADAMS, ESQ., Suite 1231, 17 Battery Place, New York, NY, 10004, US

(21) Appl. No.: 11/703,011

(22) Filed: Feb. 6, 2007

(30) Foreign Application Priority Data
Feb. 17, 2006 (JP) 2006-040456

(51) Int. Cl. G04B 27/02

(52) U.S. Cl. 368/190

(57) ABSTRACT

To provide a timepiece in which, when a rocking has been performed, a setting wheel does not run onto a gear wheel of a hand setting train wheel. A setting wheel meshes with a clutch whee at a time correction time, and a mesh with the clutch wheel is released at a time hand motion time while being placed upward than the time correction time. At the time correction time, in a minute wheel, a power mesh part receiving a power from the setting wheel meshes with the setting wheel. Further, at the time hand motion time, in the minute wheel, a mesh release prevention part having been provided in an upper part of the power mesh part prevents the mesh with the setting wheel from being released.

### BACKGROUND OF THE INVENTION

1. Field of the Invention:

The present invention relates to a timepiece performing a hand setting for a time correction.

2. Description of the Prior Art:

In a rocking structure of the timepiece having a winding stem, a clutch wheel and a setting wheel, from olden times there is known the rocking structure of the timepiece, in which the clutch wheel is moved in an axial direction of the winding stem by drawing out the winding stem through a setting lever and a yoke, thereby meshing a hand setting train wheel and the clutch wheel.

This rocking structure of the timepiece is one having a complicated mechanism performing through components such as the setting lever and the yoke because the clutch wheel is moved in the axial direction of the winding stem and, further, there is a problem that also an outer diameter of a movement becomes large because there are necessary a stroke through which the clutch wheel slides and a loop part such as the yoke.

The rocking structure of the timepiece, which solves the above problem, is disclosed in JP-A-2004-184261 Gazette. In the rocking structure of the timepiece having the winding stem, the clutch wheel and the setting wheel, it is a rocking structure in which the clutch wheel is vertically moved by a clutch wheel moving member, thereby meshing the clutch wheel and the setting wheel of the hand setting train wheel or releasing the mesh. In this conventional rocking structure of the timepiece, the winding stem is slidably held to a main plate, and a bead part of the winding stem is caught to a through-hole of a spring member. The clutch wheel is guided between the bead part and a winding stem angular part. A leaf spring or a coil spring is disposed between an outer periphery of the clutch wheel and the main plate.

As a problem of the prior art, when the rocking has been performed by moving the winding stem, meshes between the setting wheel and the hand setting train wheel and between the setting wheel and the clutch wheel are respectively released, thereby reducing a load of the hand setting train wheel at a normal hand motion time. However, under a state in which the mesh between the setting wheel and the hand setting train wheel is completely released, there becomes a state in which the setting wheel has run intact onto a gear wheel of the hand setting train wheel when the rocking has been performed, and the setting wheel cannot mesh with the hand setting train wheel, so that there arises a case where the hand setting cannot be performed.

### SUMMARY OF THE INVENTION

A timepiece of the invention has a setting wheel which meshes with a clutch wheel at a time correction time, and whose mesh with the clutch wheel is released at a time hand motion time while being placed upward than the time correction time, a power mesh part meshing with the setting wheel at the time correction time to thereby receive a power from the setting wheel, and a minute wheel having a mesh release prevention part having been provided in an upper part of the power mesh part, which prevents a mesh with the setting wheel from being released at the time hand motion time.

In a timepiece of the invention, the mesh release prevention part of the minute wheel is placed upward than an outer periphery of a tooth of the clutch wheel.

In a timepiece of the invention, the setting wheel has a stopper part which prevents the setting wheel from moving upward at the time hand motion time while climbing over the mesh release prevention part of the minute wheel.

In a timepiece of the invention, it has a train wheel bridge holding one of shafts without hindering a movement or a rotation of the setting wheel, and the train wheel bridge has a stopper part which prevents the setting wheel from moving upward at the time hand motion time while climbing over the mesh release prevention part of the minute wheel.

In a timepiece of the invention, it has a train wheel bridge holding the other of shafts without hindering a movement or a rotation of the setting wheel, and a main plate has a positioning part determining a position in which the setting wheel meshes with the power mesh part of the minute wheel.

### BRIEF DESCRIPTION OF THE SEVERAL VIEWS OF THE DRAWINGS

A preferred form of the present invention is illustrated in the accompanying drawings in which:

FIG. 1 is a sectional view showing a rocking structure of a timepiece of an embodiment of the invention at a normal hand motion time; and

FIG. 2 is a sectional view showing the rocking structure of the timepiece of the embodiment of the invention at a time correction time.

### DETAILED DESCRIPTION OF THE PREFERRED EMBODIMENTS

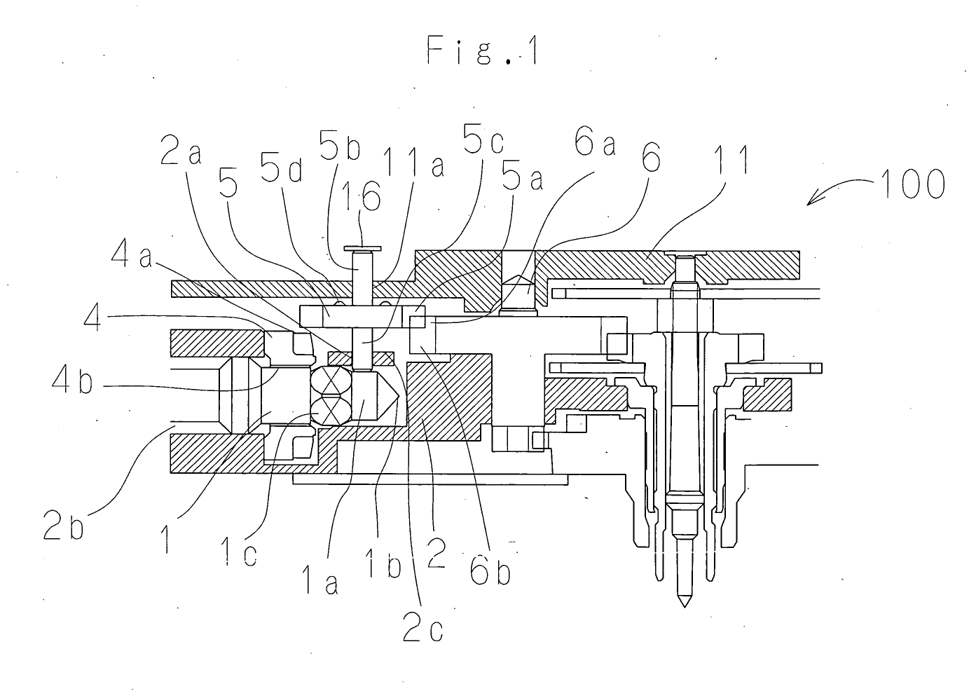

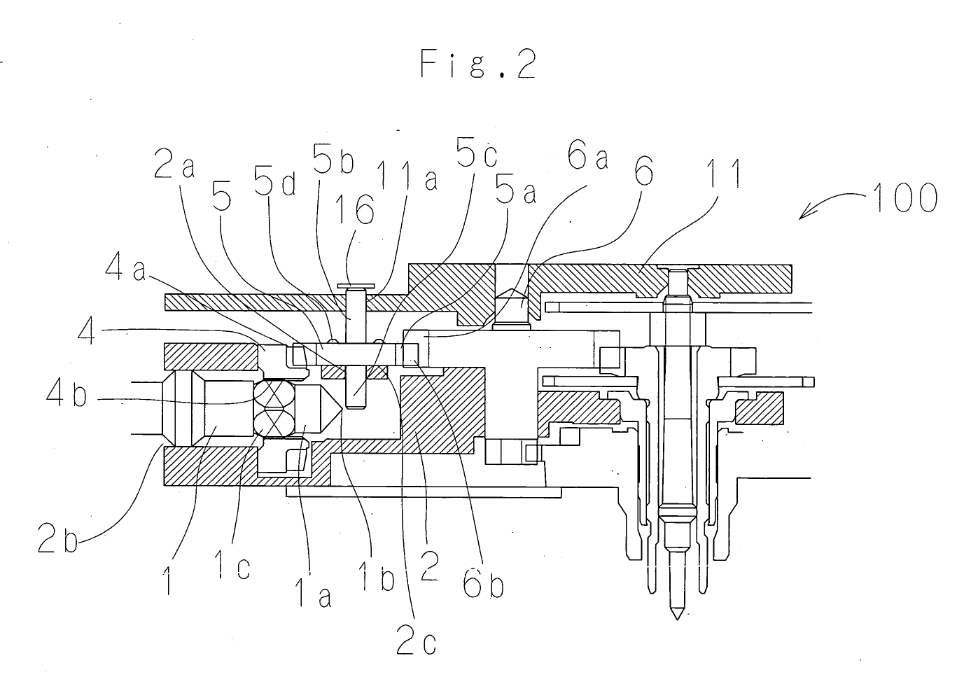

In a timepiece moved by a power source such as motor and barrel drum through plural train wheels, and having a time display wheel displaying a time with a hand being attached and a train wheel by which the time display wheel meshes with a minute wheel, a timepiece of an embodiment of the invention is explained by referring to the drawings. FIG. 1 is a sectional view at a normal hand motion time, and FIG. 2 is a sectional view at a time correction time. A timepiece 100 of the embodiment of the invention has a winding stem 1 having been attached to a main plate 2 so as to be positioned in at least two axial positions of a normal hand motion time position and a time correction time position, a clutch wheel 4 in which there has been formed an inner periphery angular hole 4b meshing with an angular part 1c of the winding stem 1, a vertically movable setting wheel 5 which is held in an upper position when the winding stem 1 has been placed in the normal hand motion time position, and which is moved to a lower position when the winding stem 1 has been placed in the time correction time position, and a minute wheel 6 meshing with the vertically movable setting wheel 5.

The setting wheel 5 is attached between the main plate 2 and a train wheel bridge 11. When existing in the above upper position, the vertically movable setting wheel 5 is released from the mesh with the clutch wheel 4, but it maintains a state having meshed with a mesh release prevention part 6a above a power mesh part 6b of the minute wheel 6. Further, when existing in the above lower position, the setting wheel 5 meshes with each of the clutch wheel 4 and the power mesh part 6b of the minute wheel 6.

That is, the vertically movable setting wheel 5 shown in FIG. 1 and FIG. 2 has a tooth 5a meshing with the clutch wheel 4, a rotation shaft comprising an upper side rotation shaft 5b and a lower side rotation shaft 5c, and a stopper part 5d regulating an upward movement quantity of the setting wheel 5. The upper side rotation shaft 5b of the setting wheel 5 is vertically, movably supported while being guided by a guide hole 11a having been formed in the train wheel bridge 11, and with the lower side rotation shaft 5c being guided by a guide hole 2a having been formed in the main plate 2. Additionally, the setting wheel 5 is applied downward with an elastic force by a setting wheel friction spring 16. The elastic force having been applied is received by the fact that an end part of the lower side rotation shaft 5c of the setting wheel 5 contacts with a tip circular cylinder part 1a of the winding stem 1.

In a case where the setting wheel 5 moves more upward than the normal hand motion position, the stopper part 5d regulating the upward movement quantity of the setting wheel 5 contacts with a lower face of the train wheel bridge 11 before the mesh between the setting wheel 5 and the mesh release prevention part 6a of the minute wheel 6 is released, thereby regulating the upward movement quantity of the setting wheel 5 and preventing the mesh release.

Additionally, the stopper part 5d of the setting wheel 5 may be two or more protrusion shapes in order to reduce a friction resistance with a train wheel bridge lower face.

Further, even if the stopper part 5d regulating the upward movement quantity of the setting wheel 5 is provided in a train wheel bridge lower face side, there is an effect regulating the upward movement quantity of the setting wheel 5.

The minute wheel 6 meshes with the setting wheel 5 at the time correction time, and has the mesh release prevention part 6a having been provided in a power mesh part upper part which prevents the mesh between the power mesh part 6b receiving a power from the setting wheel 5 and the setting wheel 5 at the a time hand motion time from releasing. The mesh release prevention part 6a is the same tooth shape as the power mesh part 6b. Incidentally, since it is not an object of the mesh release prevention part 6a to transmit the power, an accuracy of the tooth shape may be rough and, further, the mesh release prevention part 6a of the minute wheel 6 may be a taper shape.

The mesh release prevention part 6a of the minute wheel 6 is placed upward than a tooth shape outer periphery 4a of the clutch wheel 4 and, when the setting wheel 5 exists in the normal hand motion position in which the winding stem 1 has been pushed, the tip circular cylinder part 1a of the winding stem 1 enters below the lower side rotation shaft 5c of the setting wheel 5, and the setting wheel 5 is pushed up to an upper position. At this time, the setting wheel 5 is released from the mesh with the clutch wheel 4, and maintains a state having meshed with the minute wheel 6.

The setting wheel friction spring 16 is a leaf spring pushing an end part of the upper side rotation shaft 5b of the setting wheel 5 from above. This leaf spring can be formed by utilizing a spring component of a plus terminal of a battery, and the like. However, a member applying a downward elastic force to the setting wheel 5 is not one limited to the setting wheel friction spring 16 of the leaf spring shown in FIG. 1 and FIG. 2. For example, the leaf spring or the coil spring, which has been disposed between an upper face of the setting wheel 5 and a lower face of the opposing train wheel bridge 11, can be also utilized as the setting wheel friction spring 16.

The clutch wheel 4 has the inner periphery angular hole 4b meshing with the angular part 1c of the winding stem 1 slidably held while being guided by a guide hole 2b having been formed in the main plate 2. Further, the angular part 1c of the winding stem 1 in the normal hand motion time position does not mesh with the inner periphery angular hole 4b having been formed in the clutch wheel 4. However, by the normal hand motion time position of the setting wheel 5, the mesh between the setting wheel and the clutch wheel 4 is released. Since a drive from the power source is not transmitted, the angular part 1c of the winding stem 1 in the normal hand motion time position may mesh with the inner periphery angular hole 4b having been formed in the clutch wheel 4.

In the timepiece 100 of the embodiment having been explained above, when the winding stem 1 exists in the normal hand motion time position having been pushed, as shown in FIG. 1, the tip circular cylinder part 1a of the winding stem 1 enters below the lower side rotation shaft 5c of the setting wheel 5, and the setting wheel 5 is pushed up to an upper position. Thereupon, since the setting wheel 5 is released from the mesh with the clutch wheel 4 under a state having meshed with the minute wheel 6, the power from the winging stem 1 cannot transmit the clutch wheel 4 to the setting wheel 5, so that the timepiece becomes a normal hand motion state.

Further, in a case where the setting wheel 5 existing in the upper position under the normal hand motion state has been moved upward than the normal hand motion position by a disturbance such as impact, an upward movement quantity of the setting wheel 5 is regulated by the stopper part 5d of the setting wheel 5 and the train wheel bridge lower face, thereby preventing a mesh release between the setting wheel 5 and the mesh release prevention part 6a of the minute wheel 6.

When the winding stem 1 exists in the time correction time position drawn out by one stage, as shown in FIG. 2, since a tip 1b of the winding stem 1 completely separates from the lower side rotation shaft 5c of the setting wheel 5, the setting wheel 5 is pushed down to a lower position by an elasticity of the setting wheel friction spring 16. Thereupon, by the fact that the setting wheel 5 meshes with the clutch wheel and the tooth 5a of the setting wheel 5 meshes with the power mesh part 6b of the minute wheel 6 respectively, a torque is transmitted from the winding stem 1 to a hand rotation train wheel in order from the winding stem 1 to the clutch wheel 4, from the clutch wheel 4 to the setting wheel 5, and from the setting wheel 5 to the minute wheel 6, and there becomes a time correction state.

If the winding stem tip part 1b completely separates from the lower side rotation shaft 5c of the setting wheel 5, an elastic force of the setting wheel friction spring 16 is applied downward, and the setting wheel 5 is pushed down. The setting wheel 5 having been pushed down is positioned by a positioning part 2c of the main plate 2. The positioning part 2c of the main plate 2 positions the setting wheel 5 in a position where the setting wheel 5 pushed down to the lower position by the elasticity of the setting wheel friction spring 16 meshes, with the clutch wheel 4.

The setting wheel 5 is held in the upper position when it has been placed in the normal hand motion position, and moved to the lower position when the winding stem 1 has been placed in the time correction time position. Further, in both cases of the normal hand motion position and the time correction position, it is possible to smoothly perform the rocking without the fact that the setting wheel 5 meshing with the minute wheel 6 runs onto the minute wheel 6.

What is claimed is:

1. A timepiece comprising:
a setting wheel which meshes with a clutch wheel at a time correction time, and whose mesh with the clutch wheel is released at a time hand motion time while being placed upward than the time correction time;
a power mesh part meshing with the setting wheel at the time correction time to thereby receive a power from the setting wheel; and
a minute wheel having a mesh release prevention part having been provided in an upper part of the power mesh part, which prevents a mesh with the setting wheel from being released at the time hand motion time.

2. A timepiece according to claim 1; wherein the mesh release prevention part of the minute wheel is placed upward than an outer periphery of a tooth of the clutch wheel.

3. A timepiece according to claim 1, wherein the setting wheel has a stopper part which prevents the setting wheel from moving upward at the time hand motion time while climbing over the mesh release prevention part of the minute wheel.

4. A timepiece according to claim 2, wherein the setting wheel has a stopper part which prevents the setting wheel from moving upward at the time hand motion time while climbing over the mesh release prevention part of the minute wheel.

5. A timepiece according to claim 1, wherein it has a train wheel bridge holding one of shafts without hindering a movement or a rotation of the setting wheel; and the train wheel bridge has a stopper part which prevents the setting wheel from moving upward at the time hand motion time while climbing over the mesh release prevention part of the minute wheel.

6. A timepiece according to claim 2, wherein it has a train wheel bridge holding one of shafts without hindering a movement or a rotation of the setting wheel; and the train wheel bridge has a stopper part which prevents the setting wheel from moving upward at the time hand motion time while climbing over the mesh release prevention part of the minute wheel.

7. A timepiece according to claims 1; wherein it has a train wheel bridge holding the other of shafts without hindering a movement or a rotation of the setting wheel, and the main plate has a positioning part determining a position in which the setting wheel meshes with the power mesh part of the minute wheel.

8. A timepiece according to claims 2; wherein it has a train wheel bridge holding the other of shafts without hindering a movement or a rotation of the setting wheel,, and the main plate has a positioning part determining a position in which the setting wheel meshes with the power mesh part of the minute wheel.

9. A timepiece according to claims 3; wherein it has a train wheel bridge holding the other of shafts without hindering a movement or a rotation of the setting wheel, and the main plate has a positioning part determining a position in which the setting wheel meshes with the power mesh part of the minute wheel.

10. A timepiece according to claims 5; wherein it has a train wheel bridge holding the other of shafts without hindering a movement or a rotation of the setting wheel, and the main plate has a positioning part determining a position in which the setting wheel meshes with the power mesh part of the minute wheel.
